(19) United States
(12) Patent Application Publication
(10) Pub. No.: US 2013/0278812 A1
(43) Pub. Date: Oct. 24, 2013

(54) LOW POWER AUTO-FOCUS DEVICE

(71) Applicant: PING-HAN KU, Tu-Cheng (TW)

(72) Inventor: PING-HAN KU, Tu-Cheng (TW)

(73) Assignee: HON HAI PRECISION INDUSTRY CO., LTD., Tu-Cheng (TW)

(21) Appl. No.: 13/564,733

(22) Filed: Aug. 2, 2012

(30) Foreign Application Priority Data
Apr. 23, 2012 (TW) 101114309

(51) Int. Cl. H04N 5/232

(52) U.S. Cl. 348/345; 348/E05.055

(57) ABSTRACT

An auto-focus device includes a distance sensor, an actuator, a digital auto-focusing unit, and a controller. The distance sensor is configured for measure an object distance from an object to a lens module. The actuator is configured for drive the lens module to focus on an image sensor. The digital auto-focus unit is configured to process a blur image captured by the image sensor without focusing the lens module on the image sensor to get a sharp image. The controller is configured to activate the actuator when the object distance is shorter than a preset distance or otherwise activate the digital auto-focus unit.

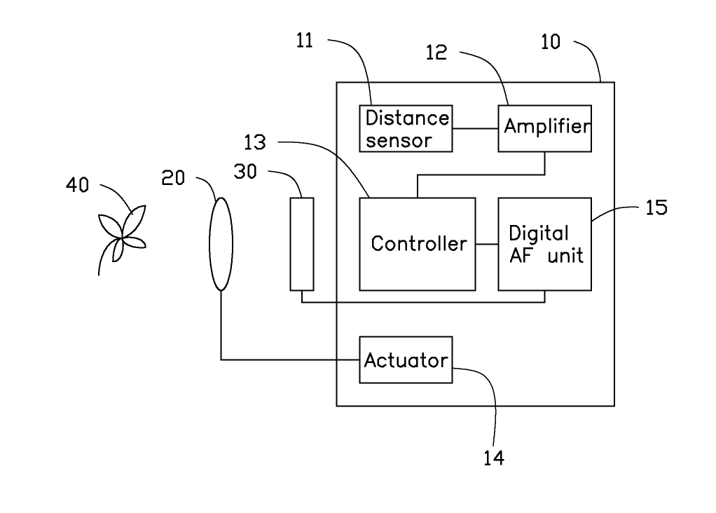

### BACKGROUND

1. Technical Field

The present disclosure relates to auto-focus (AF) technologies and, particularly, to a lower-power AF device.

2. Description of Related Art

Voice coil motors (VCMs) are widely used as AF actuators for camera modules. However, the VCMs' high power consumption is an issue particularly for far-field focusing.

Therefore, it is desirable to provide an AF device, which can overcome the above-mentioned shortcomings

### BRIEF DESCRIPTION OF THE DRAWING

The FIGURE is a schematic diagram of an AF device according to an embodiment.

### DETAILED DESCRIPTION

Embodiments of the disclosure will be described in detail, with reference to the accompanying drawing.

Referring to the FIGURE, an AF device 10, according to an embodiment, is configured to focus a lens module 20 on an image sensor 30, thus allowing the image sensor 30 to capture a sharp image.

The AF device 10 includes a distance sensor 11, an amplifier 12, a controller 13, an actuator 14, and a digital AF unit 15.

The distance sensor 11, such as an ultrasonic sensor or an infrared sensor, is fixedly positioned in relative to the lens module 20 and configured to measure an object distance from an object 40 to the lens module 20 and generate a distance signal corresponding to the object distance.

The amplifier 12 is in communication with the distance sensor 11 and configured to amplify the distance signal if the distance signal is faint. In other embodiments, if the distance signal is intense enough for post-processing, the amplifier 12 can be omitted.

The controller 13 is in communication with the amplifier 12 in this embodiment or directly in communication with the distance sensor 11 in the embodiments in which the amplifier 12 is omitted. The controller 13 is configured to activate the actuator 14 when the object distance is shorter than a preset distance or, otherwise, activate the digital AF unit 15.

In practice, the distance signal is in a form of electric current, that is, the object distance can be represented by an electric current value. The longer the object distance is, the more intense the distance signal is. Correspondingly, the preset distance is represented by an electric current value.

Initially, both the actuator 14 and the digital AF unit 15 are inactivated. The controller 13 compares the electric current values of the distance signal and the preset distance, and determines that the object distance is shorter than the preset distance if the electric current value of the distance signal is lower than that of the preset distance, and activates the actuator 14 while keeping the digital AF module 15 inactivated. Otherwise, the controller 13 determines that the object distance is longer than the preset distance if the electric current value of the distance signal is equal to or higher than that of the preset distance, and activates the digital AF module 15 actuator 14 while keeping the actuator 14 inactivated.

If the object distance is shorter than the preset distance, a near-field focusing will be performed to the lens module 20. The preset distance is set equal to a depth of filed of near-field focusing.

The actuator 14, such as a piezoelectric motor or a VCM, is in communication with the controller 13 and configured to drive the lens module 20 to focus on the image sensor 30.

The digital AF unit 15 may employ an extend depth of field technology to process a blur image captured by the image sensor 30 without really focusing the lens module 20 on the image sensor 30 to get a sharp image.

As such, the actuator 14 is inactivated in far-field focusing and thus power can be saved.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An auto-focus device, comprising:
a distance sensor configured for measure an object distance from an object to a lens module;
an actuator configured for drive the lens module to focus on an image sensor;
a digital auto-focus unit configured to process a blur image captured by the image sensor without focusing the lens module on the image sensor to get a sharp image; and
a controller in communication with the distance sensor, the actuator, and the digital auto-focus unit, the controller configured to activate the actuator when the object distance is shorter than a preset distance or otherwise activate the digital auto-focus unit.

2. The auto-focusing device of claim 1, wherein the distance sensor is selected from the group consisting of an ultrasonic sensor and an infrared sensor.

3. The auto-focusing device of claim 1, further comprising an amplifier, the distance sensor being configured for generating a distance signal corresponding to the object distance, the controller being in communication with the distance sensor through the amplifier, the amplifier being configured for amplifying the distance signal.

4. The auto-focusing device of claim 1, wherein the distance sensor is configured for generating a distance signal corresponding to the object distance, the distance signal is in a form of electric current, the preset distance is represented by an electric current value, the controller is configured to compare electric current values of the distance signal and the preset distance, the controller is configured to determine that the object distance is shorter than the preset distance when the electric current value of the distance signal is shorter than the preset distance.

5. The auto-focusing device of claim 1, wherein the actuator is configured to perform a near-field focusing on the lens module.

6. The auto-focusing device of claim 1, wherein the preset distance is substantially equal to a depth of field of a near-field focusing of the lens module.

7. The auto-focusing device of claim 1, wherein the actuator is selected from the group consisting of a piezoelectric motor and a voice coil motor.

8. The auto-focusing device of claim 1, wherein the digital auto-focusing unit employs extend depth of field technology to process the blur image.
